(19) United States
(12) Patent Application Publication
(10) Pub. No.: US 2024/0119339 A1
(43) Pub. Date: Apr. 11, 2024

(54) MACHINE LEARNING-BASED PART SELECTION BASED ON ENVIRONMENTAL CONDITION(S)

(71) Applicant: INTERNATIONAL BUSINESS MACHINES CORPORATION, Armonk, NY (US)

(72) Inventors: John S. WERNER, Fishkill, NY (US); Arkadiy O. TSFASMAN, Wappingers Falls, NY (US); Dane WARREN, Highland, NY (US); Charles BENE, Poughkeepsie, NY (US); Ryan MULHERN, Mahopac, NY (US); Thomas C. REED, Tucson, AZ (US)

(21) Appl. No.: 17/936,492

(22) Filed: Sep. 29, 2022

(51) Int. Cl. G06N 20/00; G06K 9/62

(52) U.S. Cl. CPC G06N 20/00; G06K 9/6215; G06K 9/6251; G06K 9/6256; G06K 9/6262

(57) ABSTRACT

Machine learning-based part selection in relation to one or more end use environmental conditions is provided. The process includes training a machine learning model to facilitate evaluation of a part for use in a product based on an environmental condition. Further, the process includes receiving measurement data for the part, and establishing a score for the part by comparing the measurement data for the part to a specification for the part. In addition, the method includes using the machine learning model and the established score for the part in determining whether to use the part in the product based on the environmental condition.

### BACKGROUND

One or more aspects relate, in general, to machine-learning-based processing, and in particular, to machine-learning-based processing for assisting with product fabrication.

An end product, such as a computer product (for instance, mainframe computer, server, workstation, personal computer, minicomputer, laptop, smartphone, electronic device, etc.), is built from many parts (or components), one or more of which need to conform to a design specification. The design specification typically sets forth a small range of manufacturing tolerance for the part. By way of example, a part's design specification may include, but not be limited to, part dimension(s), torque, weight, time, temperature, quantity, luminosity, voltage, current, impedance, etc., depending on the particular mechanical and/or electrical part and its function. Even though an end product, such as a computer product, meets all design specifications when installed, it is possible for one or more parts of the product to fail over time, and to require replacement. Failure of a part can possibly compromise product operation and/or make the product unusable until the part is replaced, potentially resulting in lost revenue. In addition, replacement of a part can be expensive, depending on the part and product involved.

### SUMMARY

Shortcomings of the prior art are overcome, and additional advantages are provided through the provision, in one or more aspects, of a computer program product for facilitating processing within a computing environment. The computer program product includes one or more computer-readable storage media and program instructions embodied therewith. The program instructions are readable by a processing circuit to cause the processing circuit to perform a method which includes training a machine learning model to facilitate evaluation of a part for use in a product based on an environmental condition. The method further includes receiving, at the processing circuit, measurement data for the part, and establishing, by the processing circuit, a score for the part by comparing the measurement data for the part to a specification for the part. Further, the method includes using the machine learning model and the established score for the part in determining whether to use the part in the product based on the environmental condition.

Computer systems and computer-implemented methods relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present invention;

FIG. 2A depicts another example of a computing environment to incorporate and/or use one or more aspects of the present invention;

FIG. 2B depicts one example of an augmented reality-assist device which can facilitate part selection, in accordance with one or more aspects of the present invention;

FIG. 3 depicts one embodiment of a scoring module workflow, in accordance with one or more aspects of the present invention;

FIG. 4A illustrates another example of a computing environment to incorporate and/or use one or more aspects of the present invention;

FIG. 4B depicts a self-organized map example produced by a machine learning model in an optimal part AI module workflow, in accordance with one or more aspects of the present invention;

FIG. 5 depicts one embodiment of a build module workflow, in accordance with one or more aspects of the present invention; and

FIG. 6 depicts another embodiment of a computing environment to include and/or use one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, or tools only as examples, and not by way of limitation. Furthermore, the illustrative embodiments are described in certain instances using particular software, hardware, tools, or data processing environments only as example for clarity of description. The illustrative embodiments can be used in conjunction with other comparable or similarly purposed structures, systems, applications, or architectures. One or more aspects of an illustrative embodiment can be implemented in software, hardware, or a combination thereof.

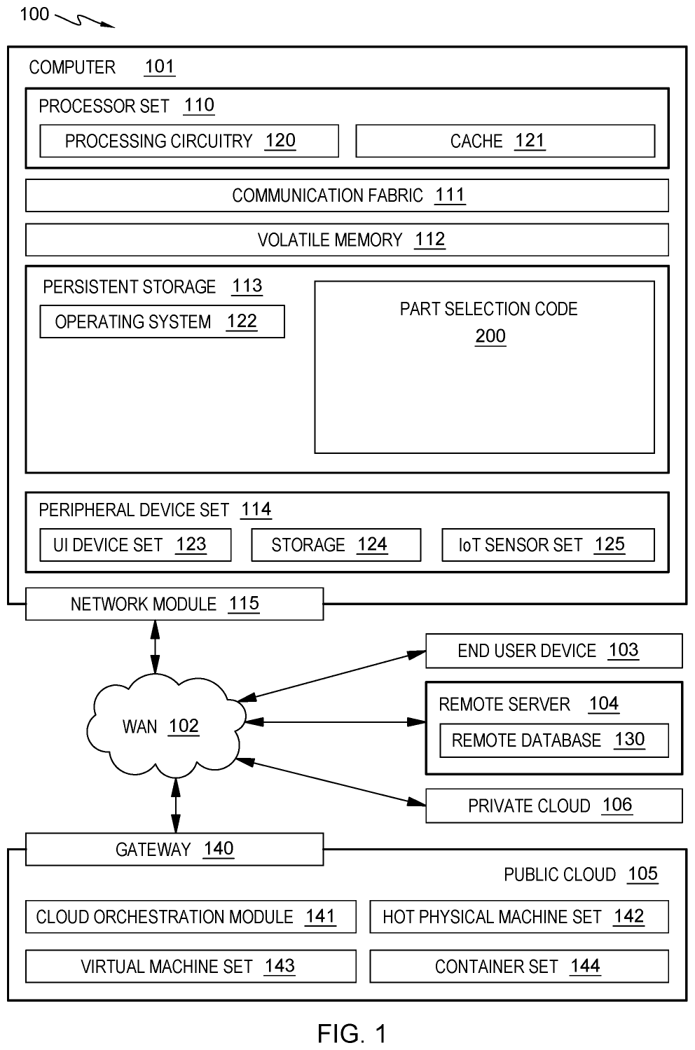

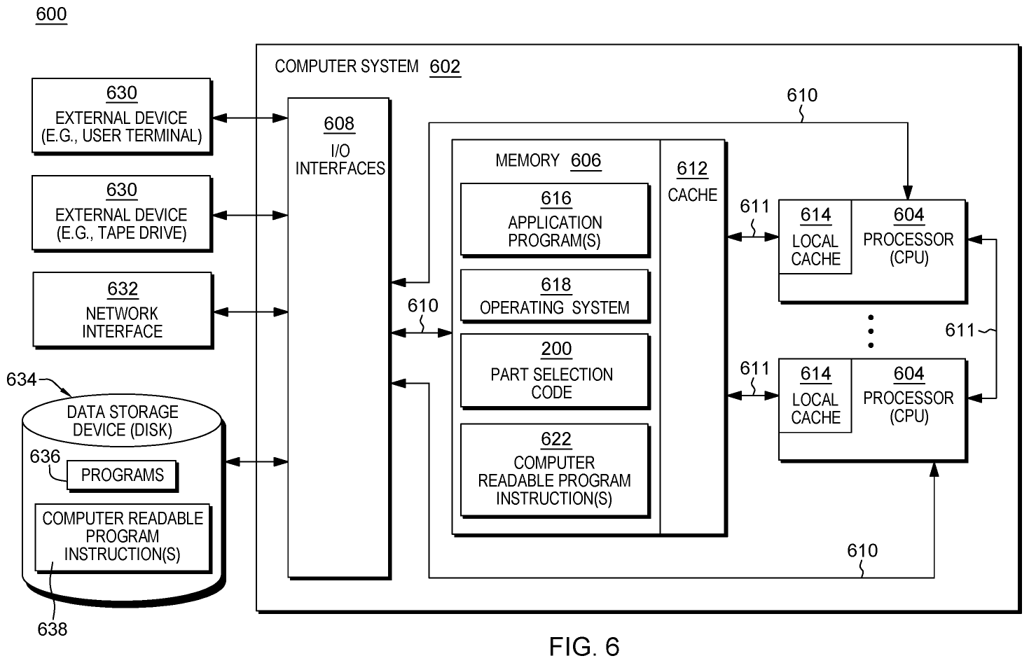

As understood by one skilled in the art, program code, as referred to in this application, can include software and/or hardware. For example, program code in certain embodiments of the present invention can utilize a software-based implementation of the functions described, while other embodiments can include fixed function hardware. Certain embodiments combine both types of program code. Examples of program code, also referred to as one or more programs, are depicted in FIG. 1 as operating system 122 and part selection code 200, which are stored in persistent storage 113. In another example, program code depicted in the computing environment of FIG. 6 includes, in part, application program(s) 616, operating system 618, part selection code 200, and computer-readable program instruction(s) 622, which are stored in memory 606 of computer system 602. Note that although shown separately in FIG. 6, part selection code 200 could be, in one or more other embodiments, associated with or part of application program(s) 616 and/or computer-readable program instruction(s) 622.

Prior to describing embodiments of the present invention, an example of a computing environment to include and/or use one or more aspects of the present invention is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as part selection code block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 126 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As noted, many end products, such as computer products, are built from many parts, one or more of which need to conform to its respective design specification(s). A design specification for a part typically sets forth a small range of manufacturing tolerance for the part for one or more particular attributes. By way of example, a part's design specification can include, but not be limited to, specification of one or more attributes, such as part dimensions, torque, weight, time, temperature, quantity, luminosity, voltage, current, impedance, etc., for the part depending on the particular part and its function. Even though a product, such as a computer product, meets all design specifications when installed, it is possible for one or more parts of the product to fail over time, and to require replacement. As noted, failure of a part can possibly compromise the product operation, and/or make the end product unusable until the part is replaced, potentially resulting in lost revenue to the end user. In addition, replacement of a failing part can be expensive, depending on the part and product involved. Environmental conditions can be a significant contributor to failure of a part over time.

Disclosed herein are computer program products, computer systems, and computer-implemented methods which facilitate processing within a computing environment, and further, which facilitate assembly of a product by assisting with selection of an optimal part for the product. Note that, as used herein, a part refers to a piece, element, component, module, or portion of a larger end product, such as a computer product. In one or more embodiments, the method includes training a machine learning model to facilitate (or assist with) evaluation of a part for use in a product in relation to (or based on) an environmental condition, such as based on one or more anticipated environmental conditions within which the end product is to operate. Further, the method includes receiving measurement data for the part, and establishing a score for the part by comparing the measurement data for the part to a specification for the part. The method also includes using the machine learning model and the established score for the part in determining whether to use the part in the product, where the determining is in relation to an environmental condition, such as an expected environmental condition for the product in use. In one or more implementations, the environmental condition can be location-dependent.

In one or more embodiments, using the machine learning model includes searching one or more data resources for past performance of the part in different environmental conditions to generate a historical performance dataset for the part, and using by the machine learning model the historical performance dataset in determining whether to use the part in the product in relation to the environmental condition. In one embodiment, determining whether to use the part in the product includes determining whether the part is an optimal for the product in relation to the environmental condition.

In one or more implementations, establishing the score for the part includes comparing the measurement data for the part to a specification tolerance for the part, with the established score being based on where the measurement data falls within the specification tolerance.

In one or more implementations, training the machine learning model includes using supervised and/or unsupervised learning to build a model of part performance in different environmental conditions. In one embodiment, the model of part performance in different environmental conditions includes a self-organized map of different environments, and training the machine learning model includes identifying part performance clusters that relate to the different environments within the self-organized map.

In one or more implementations, the method includes using clustering and part failure detection within an environment of the clustered environments of the self-organized map for part scores and part performances within the environment to establish a part failure cluster within the environment. Further, in one embodiment, using the machine learning model includes determining which environment, of the multiple environments of the self-organized map, the environmental condition most closely matches. In one implementation, the determining includes determining whether the part is an optimal part for the product in relation to the environmental condition, where the determining includes determining a Euclidian distance of the part from the part failure cluster within the environment of the self-organized map.

In one or more embodiments, disclosed herein are computer program products, computer systems, and computer-implemented methods for building an end product with a plurality of parts to reduce part failure based on one or more environmental conditions of a location where the end product is to be used. In one implementation, the method includes obtaining part measurements, establishing part scores by comparing the part measurements to respective part specifications, and utilizing an artificial intelligence (AI) system, or machine learning model, that learns from past performance of parts in different environmental conditions to identify an optimal part, or optimal parts, for the assembly of a new product based on the anticipated environmental condition(s). By considering the environmental condition(s) where the product is to be used, one or more parts of the product can be selected by the machine learning model that are in the specified range and are further optimal for the environmental condition(s) (e.g., a location-based condition), thereby potentially allowing the end product to operate longer than if another part, also within the specification range, were to be used. Note that selection among parts as used herein refers to selection among, for instance, a plurality of the same manufactured part. The manufactured parts can have slight differences, with the differences being within, in one embodiment, the specified tolerance range. However, within the tolerance range, different parts can have different measurements of a particular attribute at issue.

As an example, for a server system to be installed in a high-seismic region, the machine learning model can learn to use parts that are at the high end of their measurement specification, such that they fit together tighter and move less in the event that there is an earthquake. In another example, a server is to be assembled for use at a high altitude, in which case the machine learning model can learn to use, for instance, one or more fans in the server that have higher torque measurements on the rotor which can operate more easily since the air is thinner. If the same high torque fan were used in a system installed at a lower altitude, it would be more likely to fail due to the additional air pressure the fan would work against when rotating. This allows the manufacture of the end product to better distribute parts between products, while reducing overall failures across the product line.

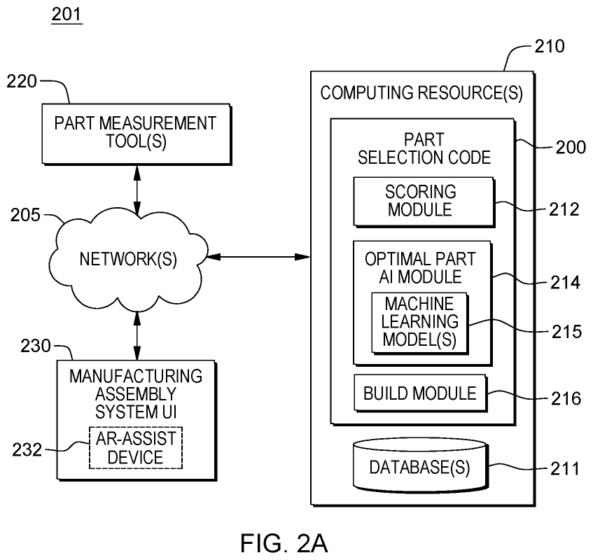

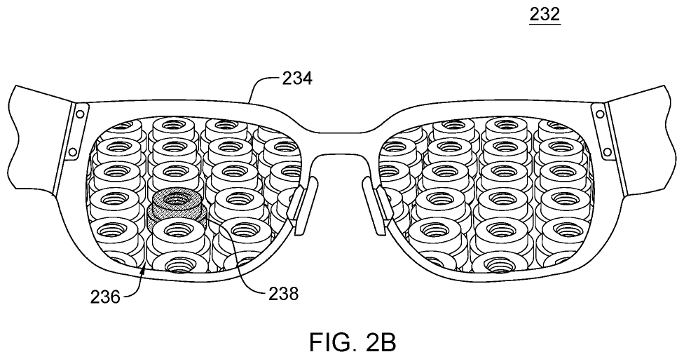

FIG. 2A depicts a further embodiment of a technical environment or system 201, into which various aspects of some embodiments of the present invention can be implemented. System 201 includes, by way of example, one or more computing resources 210 that execute program code, such as part selection code 200, and which include, or access, one or more databases 211 for storing, for instance, measurement data, part performance data, environmental condition data, historical performance datasets, etc. For illustrative purposes only, computing resource(s) 210 communicates across one or more networks 205, with one or more part measurement tools 220, and one or more manufacturing assembly systems, or assembly system user interfaces (UIs) 230. By way of example, network(s) 205 can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including measurement data for one or more parts of a product, past performance data for one or more parts of a product, identification of a selected part, etc. In one or more implementations, network(s) 205 can utilize any communication protocol that allows data to be transferred between components of computing environment 201 (e.g., Bluetooth, Wi-Fi, cellular (e.g., 3G, 4G, 5G), Ethernet, etc.).

In the embodiment of FIG. 2A, part measurement tool(s) 220 can be any tool used to measure an aspect of a product part of importance, such as, for instance, dimension, torque, weight, time, temperature, quantity, luminosity, voltage, current, impedance, etc. The actual part measurement tool(s) 220 used can vary based on the part and specification measurement requirement. Part measurement tool(s) 220 includes, but is not limited to, for instance, a caliper, a micrometer, a ruler, a scale, a torque meter, a multimeter, a voltmeter, a current clamp, etc. It is expected that all parts measured for a product will be within a specified manufacturing tolerance. However, the part measurement tool(s) 220 allow further specification of the part within the tolerance range for the part. These tools are also useful in identifying parts that do not meet a manufacturer's specification, in which case the part can be removed from consideration for use in the assembly of the product. All measurement data for parts of a product can be stored in database 211 of computing resource(s) 210, in one example. In one or more implementations, part measurement data can be ascertained by the respective part vendors, and be supplied when parts are delivered to a manufacturing facility for use in assembly of a product.

Manufacturing assembly system user interface (UI) 230 includes, for instance, a user interface to assist in obtaining parts for a specified end product being assembled or built, with one or more parts being optimal parts selected in accordance with one or more aspects disclosed herein. In one or more embodiments, the manufacturing assembly system UI 230 includes a computer program or mobile device application that assists a user in identifying whether a particular part is a good match for the end user's anticipated operating environmental conditions, as determined by the part selection code 200 (in one embodiment). Specific parts can be identified, by way of example, via a serial number (or a set of acceptable serial numbers), or can be identified by scan of a bar code and/or QR code (or any other part identifier), which identifies the particular part, including measured characteristics of the part, to determine whether the part is acceptable for the current product build based on the anticipated environmental condition.

In another embodiment, manufacturing assembly system user interface (UI) 230 can include an augmented reality-assist device 232, which can be, or include, for instance, an augmented reality (AR) device or a virtual reality (VR) device, such as augmented reality glasses (see FIG. 2B) or a virtual reality headset, or could be a smartphone with an imaging component associated therewith, as well as appropriate augmented reality or virtual reality capabilities. As used herein, an augmented reality-assist device is a device where objects that reside in the real world, or other information, can be “augmented”, or provided by computer-generated perceptible information, across one or more sensory modalities, including visual, auditory, haptic, etc. The overlaid sensory information can be constructive (i.e., additive to the natural environment depicted) or disruptive (i.e., masking of the environment depicted), and can be seamlessly interwoven with the physical world depicted in the display such that it can be perceived as an immersive aspect of the real environment. In contrast, virtual reality (VR) replaces the real world environment with a simulated environment. A virtual reality (VR) environment can be similar to the real world, or disconnected. Augmented reality systems can be considered a form of virtual reality that layers virtual information over, for instance, a real world view scene, through glasses or a live camera feed, into a headset, or onto an electronic display device. In one or more embodiments, augmented reality (AR) glasses and virtual reality (VR) headsets can consist of a head-mounted display with a small screen or lens in front of the user's field of vision.

In one or more embodiments, the AR-assist device 232 can also replace or augment one or more part measurement tools 220, and perform real-time part measurements through, for instance, the smart-glasses or mobile device, to identify optimal parts, in accordance with one or more aspects disclosed herein. FIG. 2B depicts one embodiment of an AR-assist device 232, configured as AR glasses 234, depicting parts 236, and highlighting a particular part 238, identified by part selection code 200 (FIG. 2A), for use in a current product build. In one example, AR glasses 234 can be worn by a manufacturer when assembling an end product from a plurality of same parts, one or more of which are selected using part selection code, such as disclosed herein.

In one or more implementations, when viewing a plurality of parts 236 (bearings, or fasteners, by way of example), AR glasses 234 can either perform real-time measurements, or extract, for instance, a serial number of previously measured parts 236, such that an optimal part 238 for the current product build can be highlighted, as shown. In one or more other embodiments, a mobile device, or other AR-assist device can be used in place of AR glasses.

In one or more implementations, computing resource(s) 210 host the necessary information for scoring parts within the part specification, identifying an optimal part(s) to be used in a product build based on a trained machine learning model, and, for instance, outputting of data to manufacturing assembly system user interface (UI) 230 during the product build process to assist in the product build in relation to the anticipated environmental condition(s) of end use.

As illustrated in FIG. 2A, in one or more implementations, part selection code 200 includes a scoring module 212, an optimal part artificial intelligence (AI) module 214, with one or more machine learning models 215, and a build module 216. In one or more embodiments, computing resource(s) 210 further includes one or more databases 211, which can contain a plurality of data including, but not limited to, measurement data for all parts, collected from, for instance, part measurement tool(s) 220, part scores provided by scoring module 212, part specifications, environmental data about different end product locations, as well as which parts are installed in each end product, artificial intelligence (AI) training data (i.e., machine learning data), etc.

In one or more embodiments, scoring module 212 comprises program code that receives measurement data for a part, such as data from part measurement tool(s) 220, and provides a score of the part measurement within the allowable part specification tolerance. In one or more embodiments, a scoring algorithm is used which normalizes measurement data with respect to the part specification requirement(s). Parts which land closer to one side of the normalized score can be optimal for use in one geographic location or one environmental condition, while parts closer to the other side of the normalized scale may be optimal for use in a different geographic location or different environmental condition. In one or more embodiments, the established part score(s) for a part can be stored in database 211.

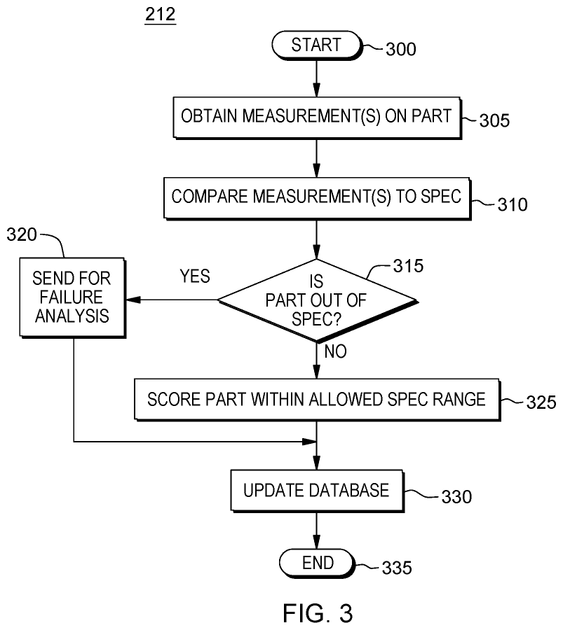

One embodiment of processing implemented by scoring module 212 is depicted in FIG. 3. In the example depicted, scoring module processing starts 300 with obtaining measurements or measurement data for a part 305. The measurement data can be mechanical and/or electrical property data, including, but not limited to, one or more dimensions, torque, weight, time, temperature, quantity, luminosity, voltage, current, impedance, etc. Measurements can come directly from a part measurement tool(s) 220 (FIG. 2A), an augmented reality (AR) manufacturing assembly user interface (UI) 230 (FIG. 2A), and/or from measurement(s) taken earlier, such as by a manufacturer, and stored in database 211 of FIG. 2A.

As shown in the example of FIG. 3, the obtained measurement data for the part is compared to a specification for the part 310. In one or more embodiments, the part specification can include specification data for the part that is prestored, such as in database 211 of FIG. 2A. The process determines whether any of the measurements obtained indicate that the part is outside of the allowable specification tolerance for the part 315. If “yes”, then the part is sent for failure analysis 320, or in one or more embodiments, discarded, or otherwise set aside as not usable within the product. Where it is determined that the part is within specification tolerances, then a score is assigned to the part 325. In one or more embodiments, a normalized score can be assigned based on the allowable tolerance for a given measurement, as in the following example:

$$Scoring range : 0 - 100 \\ Dimension Spec from database 211 : 50 mm + / - 2 mm \\ Actual measurement from part measurement tool 110 : 51.25 mm \\ \frac{Measurement - {Spec}_{min}}{{Spec}_{max} - {Spec}_{min}} * 100 = \frac{51.25 mm - 48 mm}{52 mm - 48 mm} * 100 = 81.25$$

In one or more embodiments, the desired measurements can be used by the optimal part artificial intelligence (AI) module 214, and a score need not be expressly determined for every part going forward. Rather, in one or more embodiments, assume that an end product being installed at a particular location requires a part with a dimensional score of 81.25 (as shown in the example above). In this case, the build module code 216 could directly request the part with measurement data of 51.25 mm, as one example only.

Processing updates, in one embodiment, database 211 (FIG. 2A) by storing the established score for the part and associating the score with a specific part identifier (e.g., serial number) for the part 330, which completes processing 335. In one embodiments, more than one score can be established for a given part. For instance, a fan assembly can have x, y, and z dimensional scores, a torque score on the fan rotor, a weight score, a voltage score, a current score, a power score, and an impedance score, by way of example only. Thus, in one or more embodiments, the score can be part attribute-dependent, and in one or more embodiments, determining whether to use a particular part within a product in relation to the environmental condition can be based on one or more part attribute-dependent scores, as well as one or more machine learning models, such as described herein.

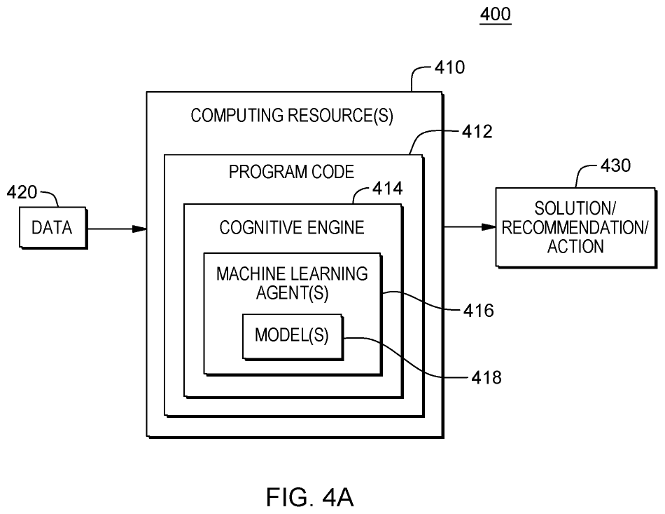

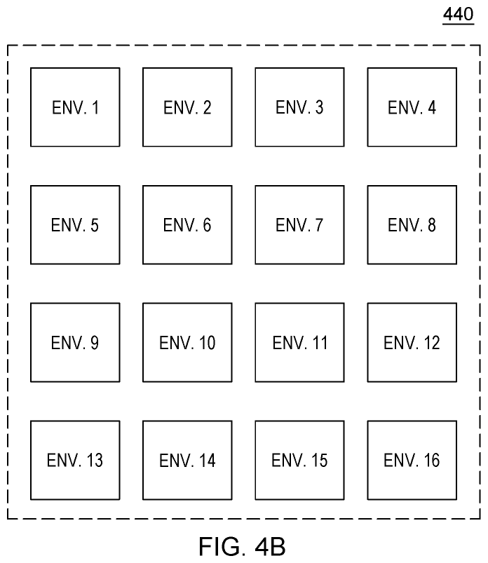

Before describing one or more embodiments of optimal part artificial intelligence (AI) module 214, with machine learning model(s) 215, FIG. 4A depicts a further embodiment of a computing environment or system 400, incorporating, or implementing, certain aspects of an embodiment of the present invention. In one or more implementations, system 400 can be part of a computing environment, such as computing environment 100 described above in connection with FIG. 1. System 400 includes one or more computing resources 410 that execute program code 412 that implements, for instance, an optimal part artificial intelligence (AI) module or facility, and includes a cognitive engine 414, which has one or more machine-learning agents 416, and one or more machine-learning models 418. Data 420, such as the data metrics discussed herein, is used by cognitive engine 414, to train model(s) 418, to (for instance) select a particular part for use in a product in relation to one or more environmental conditions, and to generate one or more recommendations or actions 430, etc., based on the particular application of the machine-learning model. In implementation, system 400 can include, or utilize, one or more networks for interfacing various aspects of computing resource(s) 410, as well as one or more data sources providing data 420, and one or more systems receiving the decision regarding use of a part in a product, other output action, etc., 430 of machine-learning model(s) 418. By way of example, the network can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, and an output solution, recommendation, action, of the machine-learning model, such as discussed herein.

In one or more implementations, computing resource(s) 410 houses and/or executes program code 412 configured to perform methods in accordance with one or more aspects of the present invention. By way of example, computing resource(s) 410 can be a computing-system-implemented resource(s). Further, for illustrative purposes only, computing resource(s) 410 in FIG. 4A is depicted as being a single computing resource. This is a non-limiting example of an implementation. In one or more other implementations, computing resource(s) 410, by which one or more aspects of machine-learning processing such as discussed herein are implemented, could, at least in part, be implemented in multiple separate computing resources or systems, such as one or more computing resources of a cloud-hosting environment, by way of example.

Briefly described, in one embodiment, computing resource(s) 410 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed herein are described further herein with reference to FIG. 1, as well as with reference to FIG. 6.

As noted, program code 412 executes, in one implementation, a cognitive engine 414 which includes one or more machine-learning agents 416 that facilitate training one or more machine-learning models 418. The machine-learning models are trained using training data that can include a variety of types of data, depending on the model and the data sources. In one or more embodiments, program code 412 executing on one or more computing resources 410 applies machine-learning algorithms of machine-learning agent 416 to generate and train the model(s), which the program code then utilizes to predict, for instance, performance of a particular part in a product, and depending on the application, to perform an action (e.g., provide a solution, make a recommendation, perform a task, etc.). In an initialization or learning stage, program code 412 trains one or more machine-learning models 418 using obtained training data that can include, in one or more embodiments, measurement data, environmental condition data, and/or part performance data, such as described herein.

Training data used to train the model (in one or more embodiments of the present invention) can include a variety of types of data, such as data generated by one or more part measurement tool(s) and/or data stored in one or more databases of, or accessible by, the computing resource(s). Program code, in embodiments of the present invention, can perform machine-learning analysis to generate data structures, including algorithms utilized by the program code to predict and/or perform a machine-learning action. As known, machine-learning (ML) solves problems that cannot be solved by numerical means alone. In this ML-based example, program code extract features/attributes from training data, which can be stored in memory or one or more databases. The extracted features are utilized to develop a predictor function, h(x), also referred to as a hypothesis, which the program code utilizes as a machine-learning model. In identifying machine-learning model 418, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize a machine-learning algorithm to train machine-learning model (e.g., the algorithms utilized by program code), including providing weights for conclusions, so that the program code can train any predictor or performance functions included in the machine-learning model. The conclusions can be evaluated by a quality metric. By selecting a diverse set of training data, the program code trains the machine-learning model to identify and weight various attributes (e.g., features, patterns) that correlate to enhanced performance of the machine-learned model.

Some embodiments of the present invention can utilize IBM Watson® as learning agent. IBM Watson® is a registered trademark of International Business Machines Corporation, Armonk, New York, USA in one or more jurisdictions. In embodiments of the present invention, the respective program code can interface with IBM Watson® application program interfaces (APIs) to perform machine-learning analysis of obtained data. In some embodiments of the present invention, the respective program code can interface with the application programming interfaces (APIs) that are part of a known machine-learning agent, such as the IBM Watson® application programming interface (API), a product of International Business Machines Corporation, to determine impacts of data on the machine-learning model, and to update the model, accordingly. In one or more embodiments, program code of the present invention can utilize and/or tie together multiple existing artificial intelligence (AI) applications.

In one or more embodiments of the present invention, the program code can utilize a neural network to analyze training data and/or collected data to generate an operational machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

In one or more implementations, optimal part artificial intelligence (AI) module 214 (FIG. 2A) can utilize supervised and/or unsupervised training to build a machine learning model of part performance in different environments, that is, under different environmental conditions, which can then be utilized by build module 216 when assembling a new end product using one or more analyzed parts.

As depicted in FIG. 4B, in one embodiment, clustering can be used to generate a self-organized map (SOM) 440 of operational conditions or environments (Env. 1 . . . Env. 16) that prior and/or current end products are operating within. In one or more embodiments, data points can be plotted in a multidimensional graph, with dimensions including, but not limited, one or more of temperature, humidity, dewpoint, elevation, natural disaster susceptibility, power dropping and/or outage susceptibility, etc. In one or more embodiments k-means clustering can be used to identify clusters that are representative as environments within the SOM 440. In the example of FIG. 4B, 16 clusters are identified for different environments that an end product has been exposed to, which create 16 neurons in the self-organized map (SOM) 440. As one example only, assume Environment 1 is 18-20° C., 12° C. dewpoint, at sea level, and less than 2% chance of natural disaster or power outage, while Environment 2 can be 25-27° C., 18° C. dewpoint, 1500 m above sea level, and less than 5% chance of natural disaster or power outage. Other environments can show different and/or less control or variation of environmental conditions (e.g., high variation in temperature over time, etc.).

Further, in one or more embodiments, clustering and anomaly detection (or identification) can be used on the part scores within each environment of the self-organized map 440 to identify part scores that tend to lead to end-use failures. For instance, the machine learning model can establish over time clusters of anomaly parts within each environment of the SOM that will form. For instance, a cluster of failed parts can form for fans that receive high part measurement scores for rotor torque in Environment 1 SOM 440, but do not lead to failure in Environment 2. The unsupervised model can be continuously updated with additional and/or new data on the environmental condition(s) and part performance within the environmental condition(s).

In one or more embodiments, the optimal part artificial intelligence (AI) module 214 is or includes a machine learning model 215 that is an unsupervised learning model that learns patterns from untagged datasets (i.e., data not tagged by a human, such as performed with supervised training models). Datasets used in the unsupervised training can include environmental data that the end product operated in, part scores that were used or obtained for parts used in the end product, and performance of the parts (e.g., no operational issues, failed after x months, number of correctible errors (CEs), or bit errors related to the part, number of fixes by a service operator, etc.). In one or more embodiments, information about the install location can be provided by the user of the end product (e.g., user provides the environmental conditions of an operating data center within which the product is to be used). In one or more embodiments, information about the install location can be extracted from previous products that have been installed at that location (e.g., the user may be upgrading from a previous generation of a server to a new server, and the previous generation can record environmental data measured from its sensors). In one or more embodiments, information about the install location can be extracted from publicly available information (e.g., data can be extracted using weather and/or climate information for a particular location where a product is to operate outdoors, or for extracting susceptibility to earthquakes at a particular location, or other natural disasters, etc.). In one or more embodiments, supervised training can be used with user-tagged data to indicate parts that operated as expected, parts that operated longer than expected, and/or parts that failed.

In one or more implementations, build module 216 of FIG. 2A receives input from optimal part artificial intelligence (AI) module 214 to determine one or more optimal parts for a product currently being assembled or built, and outputs that information (in one embodiment) to a manufacturing assembly system, or assembly system user interface (UI) 230. In one or more embodiments, build module 216 can also be used to determine part replacement recommendations and/or to notify a user or operator that a part is not optimal if the end product is moved to a new location with different environmental conditions.

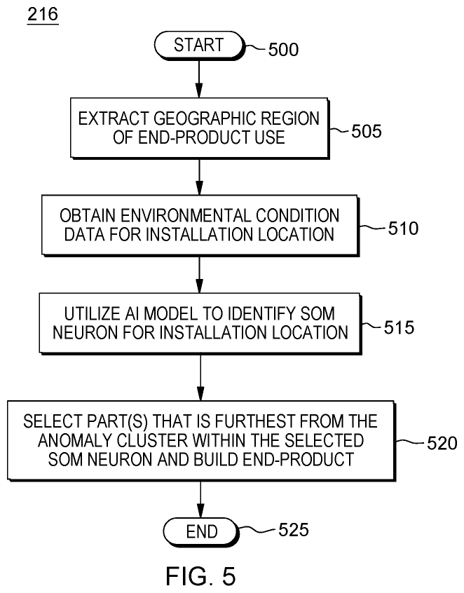

FIG. 5 depicts one embodiment of build module 216 processing. In one or more embodiments, the build module can also be used to preemptively stock parts or change parts if the end product is moved from its initially-installed location to a second location, where the two locations have different environmental conditions. As illustrated, the process begins 500 by extracting the geographic region within which an end product is to be used 505. The information can be determined, for instance, from a purchase order or shipping order, information provided by an end user, public information on an end user's location (e.g., website that lists an address, etc.), any or all of which can be stored in database 211 (FIG. 2A) for reference by build module 216, in one or more embodiments. In a further example, a server may have been purchased with the intent to be installed at a data center located, for instance, in Southern California. Processing obtains environmental data for the installation location 510. In this step, more specific environmental data for the eventual location of the end product can be extracted. By way of example, environmental data or environmental conditions of an installation location can include, but not be limited to, a temperature range, humidity range, dewpoint, altitude, natural disaster susceptibility, power dip/outage susceptibility, etc. In one or more embodiments, information about the installation location can be provided by the user of the end product (e.g., user provides environmental conditions of their data center). In one or more other embodiments, information about the install location can be extracted from previous products that have been installed at that location (e.g., where the user is upgrading from a prior generation of a server to a new server, the prior generation server can record environmental data measured from its sensors). In one or more further embodiments, information about the install location can be extracted from publicly available information (e.g., extracted weather and/or climate information for products that will operate outdoors, extracted susceptibility to earthquakes or other natural disasters, etc.). In one or more embodiments, environmental data for a given location can be stored in a database, such as database(s) 211 of the computing environment 201 of FIG. 2A.

As illustrated in FIG. 5, the machine learning model is used to identify, in one embodiment, a particular self-organized map (SOM) neuron (i.e., a particular environment of the machine-learned map) for the installation location 515. This can include, for instance, using the machine learning model to identify the closest neuron of the SOM for the installation location (i.e., for the environmental condition(s) for the new end product being built or assembled). Given an environment for the new end product, a first Euclidian distance can be determined for each environment in the SOM to determine which environment most closely matches the new environmental conditions. In one embodiment, each environmental condition can be normalized based on an operational specification for the product before determining the Euclidian distance. For instance, in the noted example, where the server is to be located in Southern California, the data obtained for a new environment is 22° C., 10° C. dewpoint, 92 m above sea level, and 10% chance of natural disaster or power outage. The specification for the end product states that operational range is 40° C. max temperature, 24° C. max dewpoint, and 3048 m max elevation, which leads to normalized values of 0.55 for temperature, 0.42 for dewpoint, 0.0003 for altitude, and 0.1 for disaster likelihood for the new environment. The calculation for the Euclidian distance from the normalized Environment 1 can be determined as shown below. A similar calculation can be performed for all environments in the self-organized map (SOM) to determine which environment is closest.

$$\begin{matrix}{d}_{Env \text{.1}} = \sqrt{\begin{matrix}\sum ( ( 0.55 - {0.475}^{2} ) - {( 0.42 - 0.5 )}^{2} - {( 0.0003 - 0. )}^{2} - \\ {( 0.01 - 0.02 )}^{2} )\end{matrix}} \\ = 0.136\end{matrix}$$

The process then selects the one or more parts that are furthest from the part failure cluster within the selected self-organized map (SOM) neuron, and builds the end product 520, which completes the process 525. Note in this regard that a second Euclidian distance can be used for part selection to account for multiple scores in different areas (for instance, length, width, height, weight, torque, etc.). In one or more embodiments, the available part (e.g., currently in the manufacturing facility) with the closest score to the desired score can be selected if an exact match does not exist at the manufacturing facility, and does not fall into the part failure cluster. In one or more embodiments, if multiple end products have been ordered, the system can select the second-closest part if the part falls closer to the part failure cluster for another order. Other variations are possible.

Those skilled in the art will note that disclosed herein is an artificial intelligence (AI) method for building an end product to minimize part failures dependent on environmental conditions of the end product. The method includes, in one or more embodiments, obtaining part measurement data, and scoring the part with reference to a part specification. The AI model, or machine learning model, is then used to determine an optimal part for a given installation location (i.e., for a given environmental condition). The product is then assembled with the optimal part for the given installation location. In one or more embodiments, the part measurement data can include one or more of a part's mechanical properties and/or electrical properties, by way of example. In one or more embodiments, the mechanical and/or electrical properties can include dimensions, torque, weight, time, temperature, quantity, luminosity, voltage, current, impedance, etc. In one implementation, scoring of a part can be based on where the part falls within an allowable tolerance, where the part score can itself be a range. In one or more implementations, clustering of data from previous and/or current end product environments can be used to build a self-organized map (SOM) using machine learning. The data used for clustering can include one or more of a temperature range, humidity range, dewpoint, altitude, natural disaster susceptibility, power dip/outage susceptibility, etc. In one embodiment, further clustering and anomaly detection can be used within each SOM neuron (or environment) for part scores and their performance within the environment of the neuron. In one embodiment, the Euclidian distance can be determined between the given location and each neuron in a SOM to determine the closest match. In one or more implementations, an optimal part is determined based on its Euclidian distance from a part failure cluster within the selected self-organized map (SOM) neuron.

In one or more implementations, provided herein are machine-learning-model-powered processes for facilitating building an end product to minimize part failures by considering anticipated environmental conditions of the end product being assembled. The method includes, in one or more embodiments, obtaining part measurements, scoring parts compared to their respective part specifications, utilizing an artificial intelligence (AI) model or machine learning model to determine optimal parts for a given installation location or environmental conditions, and assembling the product with the optimal parts for the given environmental conditions. By considering environmental conditions of the location where the end product will be used, parts can be selected using the machine learning model that are optimal within a specification range for the part, so that the part, and the end product, will operate longer within the environmental condition(s).

In one or more further embodiments, computer-implemented methods and systems for enhancing product assembly in relation to an environmental condition using artificial intelligence (AI) are provided herein. The process includes receiving, at a computer, part information for a plurality of parts of a product being assembled, and scoring each of the parts based on comparing each part to respective specifications relating to the part. The process further includes searching a data resource for past performance of each of the parts in different environments, and generating a historical performance dataset for each of the parts. The scoring of each of the parts and the historical performance dataset can then be used to determine a recommendation for a particular part to use in relation to the environmental condition.

Referring to FIG. 6, in one example, a computing environment 600 includes, for instance, a computer system 602 shown, e.g., in the form of a general-purpose computing device. Computer system 602 may include, but is not limited to, one or more processors or processing units 604 (e.g., central processing units (CPUs) and/or special-purpose processors, etc.), a memory 606 (a.k.a., system memory, main memory, main storage, central storage or storage, as examples), and one or more input/output (I/O) interfaces 608, coupled to one another via one or more buses and/or other connections. For instance, processors 604 and memory 606 are coupled to I/O interfaces 608 via one or more buses 610, and processors 604 are coupled to one another via one or more buses 611.

Bus 611 is, for instance, a memory or cache coherence bus, and bus 610 represents one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 606 may include, for instance, a cache 112, such as a shared cache, which may be coupled to local caches 614 of one or more processors 604 via, e.g., one or more buses 611. Further, memory 606 may include one or more programs or applications 616, at least one operating system 618, and part selection code 200, which implements, and/or is used in accordance with, one or more aspects of the present invention, as well as one or more computer readable program instructions 622. Computer readable program instructions 622 may be configured to carry out functions of embodiments of aspects of the invention.

Computer system 602 may communicate via, e.g., I/O interfaces 608 with one or more external devices 630, such as a user terminal, a tape drive, a pointing device, a display, and one or more data storage devices 634, etc. A data storage device 634 may store one or more programs 636, one or more computer readable program instructions 638, and/or data, etc. The computer readable program instructions may be configured to carry out functions of embodiments of aspects of the invention.

Computer system 602 may also communicate via, e.g., I/O interfaces 608 with network interface 632, which enables computer system 602 to communicate with one or more networks, such as a local area network (LAN), a general wide area network (WAN), and/or a public network (e.g., the Internet), providing communication with other computing devices or systems.

Computer system 602 may include and/or be coupled to removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media. It should be understood that other hardware and/or software components could be used in conjunction with computer system 602. Examples, include, but are not limited to: microcode, device drivers, redundant processing units, external disk drive arrays, RAID systems, tape drives, and data archival storage systems, etc.

Computer system 602 may be operational with numerous other general-purpose or special purpose computing system environments or configurations. Examples of well-known computing systems, environments, and/or configurations that may be suitable for use with computer system 602 include, but are not limited to, personal computer (PC) systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computing environments described herein are only examples of computing environments that can be used. Other environments, including but not limited to, non-partitioned environments, partitioned environments, cloud environments, distributed environments, non-distributed environments, virtual environments and/or emulated environments, may be used; embodiments are not limited to any one environment. Although various examples of computing environments are described herein, one or more aspects of the present invention may be used with many types of environments. The computing environments provided herein are only examples.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more aspects of one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, additional, fewer and/or other features, constraints, tasks and/or events may be considered. Many variations are possible.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer program product for facilitating processing within a computing environment, the computer program product comprising:
one or more computer-readable storage media having program instructions embodied therewith, the program instructions being readable by a processing circuit to cause the processing circuit to perform a method comprising:
training a machine learning model to facilitate evaluation of a part for use in a product based on an environmental condition;
receiving, at the processing circuit, measurement data for the part;
establishing, by the processing circuit, a score for the part by comparing the measurement data for the part to a specification for the part; and
using the machine learning model and the established score for the part in determining whether to use the part in the product based on the environmental condition.

2. The computer program product of claim 1, wherein using the machine learning model comprises searching one or more data resources for past performance of the part in different environmental conditions to generate a historical performance dataset for the part, and using by the machine learning model the historical performance dataset in determining whether to use the part in the product based on the environmental condition.

3. The computer program product of claim 2, wherein determining whether to use the part in the product comprises determining whether the part is an optimal part for the product in relation to the environmental condition.

4. The computer program product of claim 1, wherein establishing the score for the part comprises comparing the measurement data for the part to a specification tolerance for the part, the established score being based on where the measurement data falls within the specification tolerance.

5. The computer program product of claim 1, wherein training the machine learning model includes using at least one of supervised learning or unsupervised learning to build a model of part performance in different environmental conditions.

6. The computer program product of claim 5, wherein the model of part performance in different environmental conditions includes a self-organized map of different environments, and training the machine learning model comprises identifying part performance clusters that relate to the different environments within the self-organized map.

7. The computer program product of claim 6, further comprising using clustering and anomaly detection within an environment of the clustered environments of the self-organized map for part scores and part performances within the environment to establish a part failure cluster within that environment.

8. The computer program product of claim 7, wherein using the machine learning model comprises determining that the environmental condition most closely matches the environment of the different environments of the self-organized map.

9. The computer program product of claim 8, wherein the determining comprises determining whether the part is an optimal part for the product based on the environmental condition, the determining including determining a Euclidian distance of the part from the part failure cluster within the environment of the self-organized map.

10. A computer system for facilitating processing within a computing environment, the computer system comprising:
a memory; and
at least one processor in communication with the memory, wherein the computer system is configured to perform a method, said method comprising:
training a machine learning model to facilitate evaluation of a part for use in a product based on an environmental condition;
receiving measurement data for the part;
establishing a score for the part by comparing the measurement data for the part to a specification for the part; and
using the machine learning model and the established score for the part in determining whether to use the part in the product based on the environmental condition.

11. The computer system of claim 10, wherein using the machine learning model comprises searching one or more data resources for past performance of the part in different environmental conditions to generate a historical performance dataset for the part, and using by the machine learning model the historical performance dataset in determining whether to use the part in the product based on the environmental condition.

12. The computer system of claim 11, wherein determining whether to use the part in the product comprises determining whether the part is an optimal part for the product in relation to the environmental condition.

13. The computer system of claim 10, wherein establishing the score for the part comprises comparing the measurement data for the part to a specification tolerance for the part, the established score being based on where the measurement data falls within the specification tolerance.

14. The computer system of claim 10, wherein training the machine learning model includes using at least one of supervised learning or unsupervised learning to build a model of part performance in different environmental conditions, and wherein the model of part performance in different environmental conditions includes a self-organized map of different environments, and training the machine learning model comprises identifying part performance clusters that relate to the different environments within the self-organized map.

15. The computer system of claim 14, further comprising using clustering and anomaly detection within an environment of the clustered environments of the self-organized map for part scores and part performances within the environment to establish a part failure cluster within that environment.

16. The computer system of claim 15, wherein using the machine learning model comprises determining that the environmental condition most closely matches the environment of the different environments of the self-organized map, and wherein the determining comprises determining whether the part is an optimal part for the product based on the environmental condition, the determining including determining a Euclidian distance of the part from the part failure cluster within the environment of the self-organized map.

17. A computer-implemented method of facilitating processing within a computing environment, the computer-implemented method comprising:
training, by one or more processors, a machine learning model to facilitate evaluation of a part for use in a product based on an environmental condition;
receiving, by the one or more processors, measurement data for the part;
establishing, by the one or more processors, a score for the part by comparing the measurement data for the part to a specification for the part; and
using the machine learning model and the established score for the part in determining whether to use the part in the product based on the environmental condition.

18. The computer-implemented method of claim 17, wherein using the machine learning model comprises searching one or more data resources for past performance of the part in different environmental conditions to generate a historical performance dataset for the part, and using by the machine learning model the historical performance dataset in determining whether to use the part in the product based on the environmental condition.

19. The computer-implemented method of claim 18, wherein determining whether to use the part in the product comprises determining whether the part is an optimal part for the product in relation to the environmental condition.

20. The computer-implemented method of claim 17, wherein establishing the score for the part comprises comparing the measurement data for the part to a specification tolerance for the part, the established score being based on where the measurement data falls within the specification tolerance.
